(19) United States
(12) Patent Application Publication
(10) Pub. No.: US 2006/0133081 A1
(43) Pub. Date: Jun. 22, 2006

(54) LED light bulb structure

(76) Inventor: Chin-Ming Chen, Hsinchu Hsien (TW)

Correspondence Address: LEONG C LEI, PMB # 1008, 1867 YGNACIO VALLEY ROAD, WALNUT CREEK, CA, 94598, US

(21) Appl. No.: 11/016,780

(22) Filed: Dec. 21, 2004

(51) Int. Cl. F21V 21/00

(52) U.S. Cl. 362/249

(57) ABSTRACT

An LED light bulb structure is disclosed. The light bulb structure comprises a light bulb body and a positioning seat. The positioning seat is provided with a seat face having a recess to accommodate the LED elements, and the recess is a vertical hole which leads the correspondingly mounted LED elements, thereby the combination of the seat and the light bulb body enhances the positioning of LED elements so as to improve the brightness of the light rays in the course of illumination.

### BACKGROUND OF THE INVENTION

(a) Technical Field of the Invention

The present invention relates to LED light bulb structure, and in particular, an LED light bulb structure with enhanced positioning of LED light bulb elements so as to improve the brightness of the focused light rays.

(b) Brief Description of The Prior Art

FIG. 1 is a conventional LED light element 1 connected to a circuit board and is secured onto a bulb seat 2. This LED light bulb could provide brightness but has the following drawbacks:

The positioning of the projection angle of LED element 1 depends greatly on the tiny metallic lead at the bottom end of the element 1. However, due to impact in the course of transporting or packaging, biased angle 3 is formed and this will reduce the brightness of the focused light rays. In order to facilitate the control of material and color tone distinguishing for consumer, an adhesive label 4 having the same color with the LED light is adhered to the surface of the light bulb seat. This adhesive label 4 will dislocate and therefore the consumer has to unscrew the LED light bulb to distinguish the color tone of the light bulb. Thus, this is inconvenient to the consumer.

Accordingly, it is an object of the present invention to provide a LED light bulb structure which mitigates the above drawbacks.

### SUMMARY OF THE INVENTION

Accordingly, it is an object of the present invention to provide an LED light bulb structure having a light bulb body constituted from a plurality of LED elements, and a positioning seat to hold the LED elements, characterized in that the positioning seat is provided with a seat face having a recess to accommodate the LED elements, and the recess is a vertical hole which leads the correspondingly mounted LED elements, thereby the combination of the seat and the light bulb body enhances the positioning of LED elements so as to improve the brightness of the light rays in the course of illumination.

Another object of the present invention is to provide a LED light bulb structure, wherein the positioning of the LED element is enhanced so that the brightness of the focused light rays is improved.

Still another object of the present invention is to provide an LED light bulb structure, wherein the color of the positioning seat is a color matching with the color of the LED element.

A further object of the present invention is to provide an LED light bulb structure, wherein the recess of the positioning seat has a wall biased towards the center thereof.

Still a further object of the present invention to provide an LED light bulb structure wherein the main circuit for the LED light bulb will work when the input voltage is higher than that designed voltage (13.2V) thereby stabilizing the current flowing through the LED, and the BE knot of the transistor and the cutoff properties of the transistor is utilized to make the circuit work steadily.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional LED light bulb.

FIG. 2 is a perspective view of the LED light bulb structure of the present invention.

FIG. 3 is a perspective exploded view of the LED light bulb structure of the present invention.

FIG. 4 is a sectional view of the LED light bulb structure of the present invention.

FIG. 5 is a top view of the LED light bulb structure of the present invention.

FIG. 6 is a schematic view showing the combination structure of the positioning seat and the LED light bulb body of the present invention.

FIG. 7 is a top view of the light bulb structure shown in FIG. 6.

FIG. 8 is a circuit diagram of the present invention.

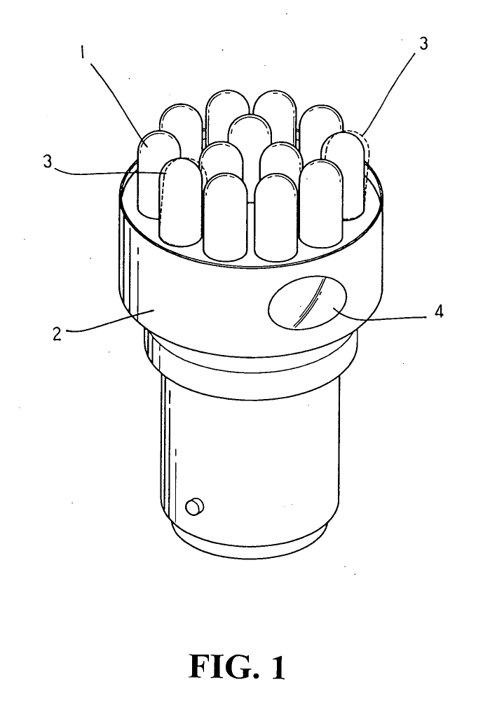

### DETAILED DESCRIPTION OF THE PREFERRED EMBODIMENT

The following descriptions are of exemplary embodiments only, and are not intended to limit the scope, applicability or configuration of the invention in any way Rather, the following description provides a convenient illustration for implementing exemplary embodiments of the invention. Various changes to the described embodiments may be made in the function and arrangement of the elements described without departing from the scope of the invention as set forth in the appended claims.

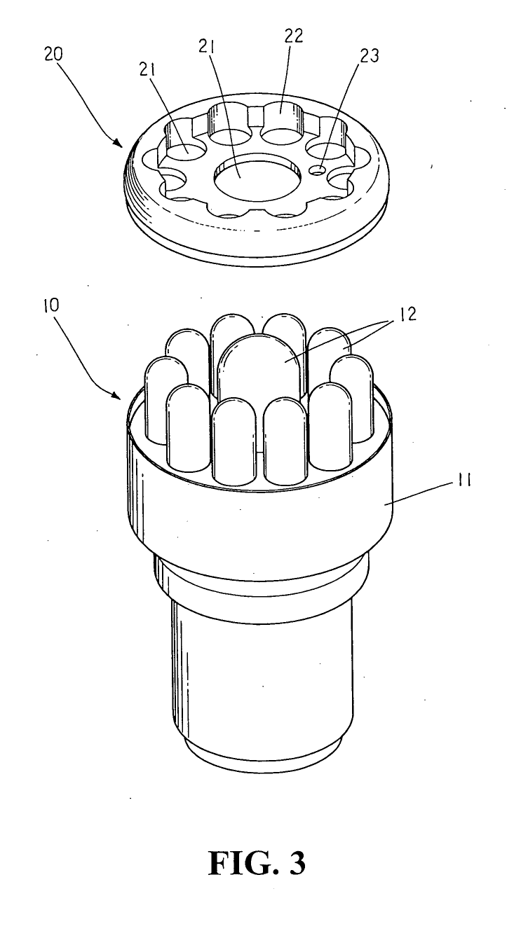

Referring FIG. 3, there is shown a LED light bulb structure comprising a light bulb body 3 having a plurality of LED elements 12, and a positioning seat 20 for the holding of the LED elements 12.

As shown in FIG. 3, the light bulb body 10 has the shape of the conventional LED light bulb, and includes a bulb seat 11 which can screw onto the bulb holder, and a plurality of LED elements 12. The bottom end of the element 12 is connected to a circuit board, and the plurality of LED elements 12 are arranged and secured onto the light bulb seat. The size and shape of the LED elements are shown in FIG. 7.

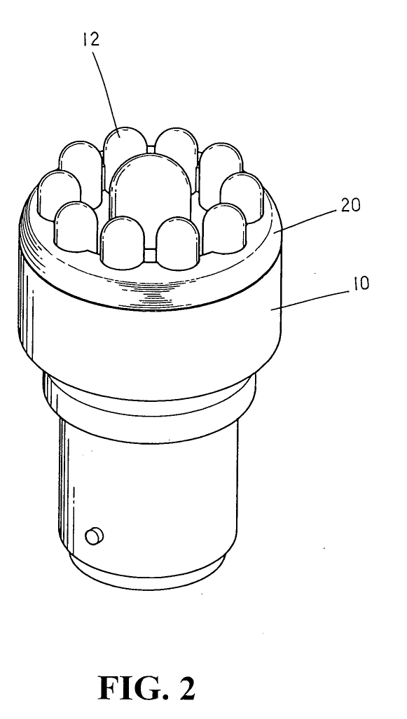

As shown in FIGS. 2 to 5, the positioning seat 20 is a seat body integrally made from plastic material, and the seat body is not higher than the LED element 12. The seat face is provided with a plurality of recesses 21 which can hold the LED elements 12 on a bulb seat 11 so that the LED elements 12 are vertically positioned.

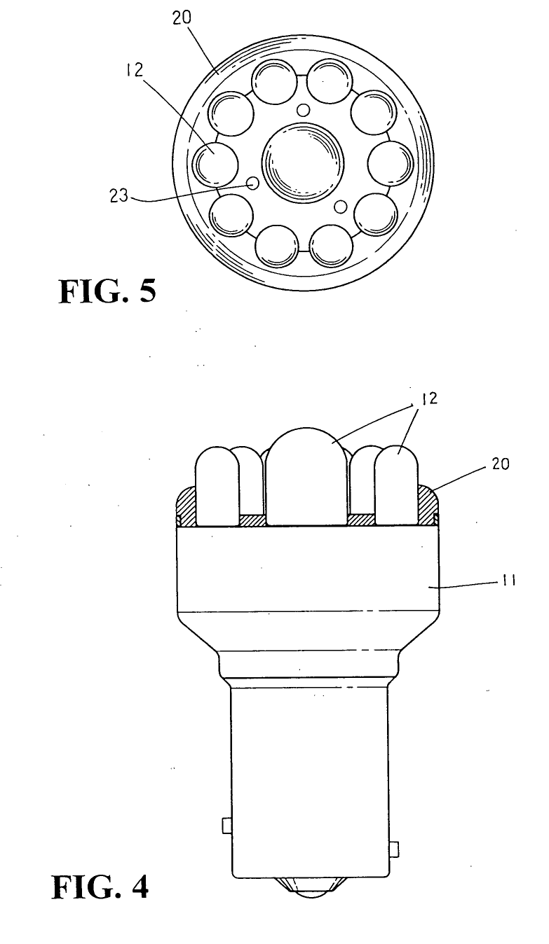

As shown in FIGS. 2 and 4, after the light bulb body 10 is secured onto the seat 20, the bulb 10 will not rotate. The side wall of the bulb seat 11 and the positioning seat 20 provide further securing, or the contacting face of the positioning seat 20 and the bulb seat 11 is provided with adhesive tape. The LED element 12 is firmly secured by the guiding of the recess 21. The LED elements 12 are held in a vertical position. Thus, the brightness of the light rays is improved.

In accordance with the present invention, the color of the positioning seat 20 is matching that of the color of light of the LED elements 12. Thus, it is convenient to the consumer in distinguishing the light color of the LED light bulb structure.

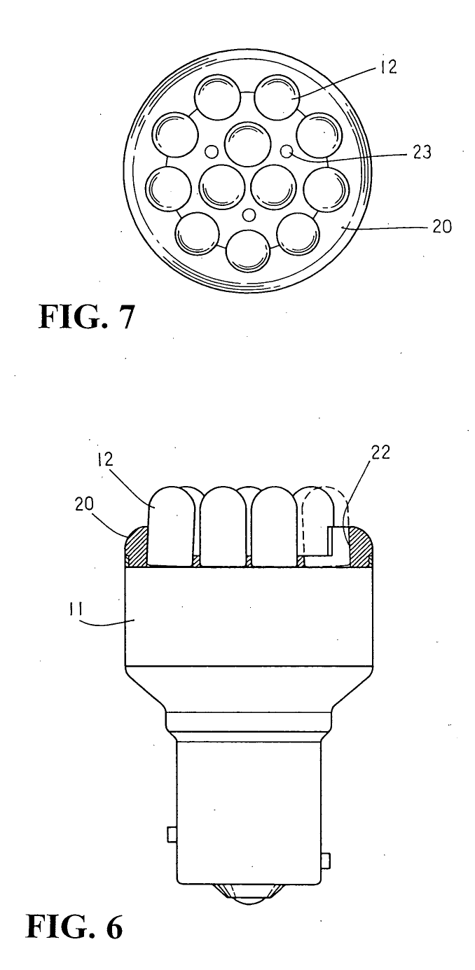

As shown in FIG. 6, the recess 21 of the positioning seat 20 is formed at the wall 22 of the hole and is biased to the center thereof.

Thus, the matrix shaped LED elements 12 are guided to project light at the center thereof so that the brightness of the light rays is improved. As shown in FIGS. 5 and 7, the seat face between the recesses 21 is further provided with holes 23 for dissipation.

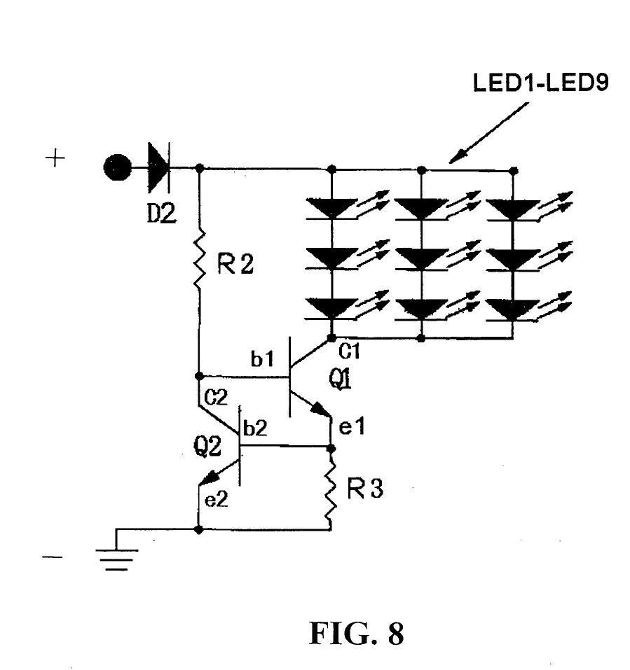

Referring to FIG. 8 which is a circuit diagram of the present invention, the circuit contains nine LED elements and the main circuit for the LED light bulb will work when the input voltage is higher than that designed voltage (13.2V) thereby stabilizing the current flowing through the LED elements, and the BE joint of the transistor and the cutoff properties of the transistor is utilized to make the circuit work steadily.

As shown in FIG. 8, the collector C1 of the transistor Q1 is connected to the negative electrode of the LED element, and the emitter E1 is connected to a current limiting resistor R3 which is then connected to the ground thereby forming a closed circuit. A resistor R2 is used for supplying a voltage for the base B1 of the transistor Q1 thereby providing base current for the transistor Q1. The base B2 of the transistor Q2 is connected to the emitter E1 of the transistor Q1, the emitter E2 of the transistor Q2 is connected to the ground, and the collector C2 of the transistor Q2 is connected to the base B1 of the transistor Q1.

The working principle of the present invention is described as follows:
1. When the voltage supplied is equal to the predetermined value, 13.2V, the resistor R2 will supply voltage to the transistor Q1 thereby providing a voltage for the LED 1 to LED 9 and causing current flowing therethrough. The voltage applied to the collector C1 of the transistor Q1 is equal to the difference between the power voltage and the LEDVF, i.e. 13.2V−LED.VF×number of LED. When the knot voltage of the base B1 and the emitter E1 is reached, current at the collector C1 will flow through the resistor R3 thereby providing a potential difference across the resistor R3. Since the resistor R3 is low in resistance, the voltage across the resistor R3 will be low thereby making it unable to conduct the transistor Q2. Hence, the transistor Q2 will not work and the circuit will only work at the predetermined value.
2. When the supplied voltage is higher than the predetermined value, the potential difference across the transistor R3 will conduct the knot BE of the transistor Q2 and a portion of the current flowing through the resistor R2 will be guided to the ground through the transistor Q2. Only a small current will flow through the base of the transistor Q1, and so the potential difference is low thus making the transistor Q1 in semi-conducting condition and therefore reducing the current flowing through the LED 1 to LED 9. When the emitter E1 is at low current and low voltage conditions, the transistor Q2 will be in cutoff condition and the transistor Q1 will work again thereby causing the LED to work at the predetermined value.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An LED light bulb structure having a light bulb body constituted from a plurality of LED elements, and a positioning seat to hold the LED elements, characterized in that the positioning seat is provided with a seat face having a recess to accommodate the LED elements, and the recess is a vertical hole which leads the correspondingly mounted LED elements, thereby the combination of the seat and the light bulb body enhances the positioning of LED elements so as to improve the brightness of the light rays in the course of illumination.

2. The LED light bulb structure of claim 1, wherein the color of the positioning seat is a color matching with the color of the LED element.

3. The LED light bulb structure of claim 1, wherein the recess of the positioning seat has a wall biased towards the center thereof.

4. The LED light bulb structure of claim 1, wherein the seat face between the recesses of the positioning seat is further provided with holes for heat dissipation.

5. The LED light bulb structure of claim 1, wherein when voltage supplied is equal to a predetermined value (13.2V), resistor (R2) will supply voltage to transistor (Q1) thereby providing a voltage for LED (1) to LED (9) and causing current flowing therethrough, and voltage applied to collector (C1) of the transistor (Q1) is equal to difference between power voltage and LEDVF (13.2V−LEDVF×number of LED), and when knot voltage of base (B1) and emitter (E1) is reached, current at collector (C1) will flow through resistor (R3) thereby providing a potential difference across the resistor (R3), and since the resistor (R3) is low in resistance, voltage across the resistor (R3) will be low thereby making it unable to conduct a transistor (Q2), and so the transistor (Q2) will not work and the circuit will only work at the predetermined value.

6. The LED light bulb structure of claim 1, wherein when supplied voltage is higher than the predetermined value, potential difference across transistor (R3) will conduct knot (BE) of transistor (Q2) and a portion of current flowing through resistor (R2) will be guided to ground through the transistor (Q2), and only a small current will flow through base of transistor (Q1), and so potential difference is low thus making the transistor (Q1) in semi-conducting condition and therefore reducing current flowing through LED (1) to LED (9.), and when emitter (El) is at low current and low voltage conditions, the transistor (Q2) will be in cutoff condition and the transistor (Q1) will work again thereby causing the LED to work at the predetermined value.
